(19) United States
(12) Patent Application Publication
(10) Pub. No.: US 2024/0190768 A1
(43) Pub. Date: Jun. 13, 2024

(54) CEMENT ADDITIVE FOR RETARDATION OF CEMENT HYDRATION, CEMENT MIXTURES INCLUDING SAME, AND METHODS OF FORMING AND USING SAME

(71) Applicant: The Regents of the University of Colorado, a body corporate, Denver, CO (US)

(72) Inventors: Wilfred V. Srubar, III, Boulder, CO (US); Xu Chen, Lafayette, CO (US)

(73) Assignee: The Regents of the University of Colorado, a body corporate, Denver, CO (US)

(21) Appl. No.: 18/285,246

(22) PCT Filed: Mar. 31, 2022
(86) PCT No.: PCT/US2022/022808

§ 371 Date: Sep. 30, 2023

Related U.S. Application Data
(60) Provisional application No. 63/168,871, filed on Mar. 31, 2021.

(51) Int. Cl. C04B 18/24; C04B 20/02; C04B 28/04; C04B 103/00; C04B 103/20

(52) U.S. Cl. CPC C04B 18/24; C04B 20/023; C04B 28/04; C04B 2103/0001; C04B 2103/20

(57) ABSTRACT

Cement mixtures comprising a hydration retarder comprising algae, cement additives comprising algae and/or derivatives thereof, and methods of forming and using the mixtures and additives are disclosed. The algae can be treated to form desired functional groups to tune retardation properties of the hydration retarder.

### CROSS REFERENCE TO RELATED APPLICATION

This application claims the benefit of U.S. Provisional Application Ser. No. 63/168,871, filed on Mar. 31, 2021, and entitled Cement Additive for Retardation of Cement Hydration, Cement Mixtures Including Same, and Methods of Forming and Using Same, the contents of which are hereby incorporated herein by reference to the extent such contents do not conflict with the present disclosure.

### FEDERALLY-SPONSORED RESEARCH

This invention was made with government support under grant number DE-AR0001145 awarded by the U.S. Department of Energy. The government has certain rights in the invention.

### FIELD OF THE DISCLOSURE

The present disclosure generally relates to cement additives. More particularly, the disclosure relates to additives suitable for retardation of cement hydration, mixtures including the additive(s), and to methods of forming and using the additives and mixtures.

### BACKGROUND OF THE DISCLOSURE

As sustainable and widely available materials, algae have been promoted as a feedstock for numerous commercial products, including in pharmaceutical, cosmetic, food and agricultural industries. Their application in cementitious materials, however, has been limited.

When water is added to cement, cement hydration occurs. During cement hydration, exothermic reactions occur, sometimes at undesirably high rates. Improved compositions and methods for providing desired control of retardation of cement hydration are therefore generally desired.

Any discussion of problems and solutions involved in the related art has been included in this disclosure solely for the purposes of providing a context for the present invention and should not be taken as an admission that any or all of the discussion was known at the time the invention was made.

### SUMMARY OF THE DISCLOSURE

This summary is provided to introduce a selection of concepts. This summary is not intended to necessarily identify key features or essential features of the claimed subject matter, nor is it intended to be used to limit the scope of the claimed subject matter.

Various embodiments of the present disclosure relate to cement mixtures, to additives for cement mixtures, and to methods of forming and using the mixtures and additives. In addition, the disclosure relates to concrete and mortar including or formed using an additive and/or mixture as disclosed herein. The cement mixtures and additives can include a hydration retarder that comprises algae.

In accordance with at least one embodiment of the disclosure, a cement mixture is provided. The cement mixture includes a weight percent hydration retarder by weight of the cement, the hydration retarder comprising algae, such as raw algal biomass. The cement can include additional compounds typically found in cement mixtures. In accordance with various examples of the disclosure, the cement mixture includes about 0.01 wt % to about 10.0 wt % or about 0.3 wt % to about 3.0 wt % algae. The algae can include any suitable algae, such as one or more of chlorella, spirulina, chlorophyta, or the like. In some cases, the algae is living, non-living, or a combination of both. In accordance with further examples, the algae comprise microalgae. The cement can include hydraulic cement, such as portland cement (e.g., Type I/II portland cement (QuikreteR) that complies with ASTM C150). In accordance with other examples, the the cement comprises one or more of basic oxygen furnace (BOF) or ground granulated blast furnace slag cement, alkali-activated cement, sulfoaluminate cement, magnesium phosphate cement, carbonated cement, calcium aluminate cements. In accordance with further examples of the disclosure, the algae comprise one or more (e.g., both) of a carboxylic acid functional group and a hydroxyl functional group. In accordance with yet further examples of the disclosure, the algae comprise algae treated with an oxidant to increase a number of one or more of the carboxylic acid functional groups and hydroxyl functional groups—e.g., increase the number of one or both of such groups, compared to the algae without such treatment.

In accordance with additional embodiments of the disclosure, a cement additive for retardation of cement hydration is provided. The cement additive is or includes algae, such as the algae described herein. The algae can be ground to an average size between about 0.1 μm and about 1 mm or about 100 μm and about 250 μm. The (e.g., ground) algae can be passed through a sieve having a size of about 125 μm or less.

In accordance with yet additional embodiments of the disclosure, a method of forming a hydration retarder for cement is provided. The method includes providing algae, and (optionally) exposing the algae to an oxidant to increase an amount of one or more of a carboxyl group and a hydroxyl group on a surface of the algae. The algae can be living and/or non-living. Exemplary methods can additionally include grinding the algae and/or passing the (e.g., ground) algae through a sieve, such as a sieve described herein. The step of exposing the algae to an oxidant can include using one or more of hydrogen peroxide, nitric acid, oxygen, sulfuric acid, potassium nitrate, halogens, such as Cl₂ and F₂, sodium perborate, nitrous oxide, ozone, peroxy disulfuric acid, peroxymonosulfuric acid, and lead dioxide, in any suitable combination.

In accordance with yet further embodiments of the disclosure, a method of retarding hydration in a composition comprising cement is provided. The method can include providing cement, and adding a hydration retarder comprising algae (e.g., any algae noted herein) as an additive to the cement.

In accordance with further exemplary embodiments, concrete formed using or comprising the cement additive and/or cement mixture, as described herein, is provided.

In accordance with further exemplary embodiments, mortar formed using or comprising the cement additive and/or cement mixture, as described herein, is provided.

These and other embodiments will become readily apparent to those skilled in the art from the following detailed description of certain embodiments having reference to the attached figures: the invention not being limited to any particular embodiment(s) disclosed.

### BRIEF DESCRIPTION OF THE DRAWING FIGURES

A more complete understanding of exemplary embodiments of the present disclosure can be derived by referring to the detailed description and claims when considered in connection with the following illustrative figures.

FIG. 1 illustrates rate of heat evolution and total heat for the cement pastes with 0.0% (control), 0.3%, 0.5%, 1.0% and 3.0% of chlorella (with respect to the weight of cement).

FIG. 2 illustrates FTIR spectrum of the raw chlorella showing the presence of various functional groups.

FIG. 3 schematically illustrates changes in the —COOH and —OH functional groups caused by the H₂O₂— and heat-treatment of algae.

FIG. 4 illustrates FTIR spectra of the raw chlorella and chlorella treated at 300° C. and with H₂O₂ solution.

FIG. 5 illustrates morphology of the (a) raw, and (b) H₂O₂— and (c) heat-treated treated chlorella.

FIG. 6 illustrates rate of heat evolution and total heat for the control cement paste (i.e., without addition of algae) and those with addition of the chlorella (raw, and H₂O₂— and heat-treated).

FIG. 7 presents SEM images of (a) control cement paste and pastes with (b) raw and (c) H₂O₂-treated chlorella when cured for 28 days.

FIG. 8 illustrates XRD patterns of control cement paste and pastes with raw and H₂O₂-treated chlorella when cured for 28 days.

FIG. 9 illustrates compressive strength of control cement paste, and pastes with raw—and H₂O₂-treated chlorella when cured for 28 days.

It will be appreciated that elements in the figures are illustrated for simplicity and clarity and have not necessarily been drawn to scale. For example, the dimensions of some of the elements in the figures may be exaggerated relative to other elements to help improve understanding of illustrated embodiments of the present disclosure.

### DETAILED DESCRIPTION OF EXEMPLARY EMBODIMENTS OF THE DISCLOSURE

Although certain embodiments and examples are disclosed below, it will be understood that the invention extends beyond the specifically disclosed embodiments and/or uses thereof and obvious modifications and equivalents thereof. Thus, it is intended that the scope of the invention disclosed should not be limited by the particular disclosed embodiments described below.

The present disclosure generally relates to cement mixtures, to additives for cement mixtures, and to methods of forming and using the mixtures and additives. In addition, the disclosure relates to concrete and mortar including or formed using an additive and/or mixture as disclosed herein. As set forth in detail below, the additive(s) can be or include algae, such as algae described herein, which can provide desired retardation of cement hydration.

In this disclosure, any two numbers of a variable can constitute a workable range of the variable, and any ranges indicated may include or exclude the endpoints. Additionally, any values of variables indicated (regardless of whether they are indicated with about or not) may refer to precise values or approximate values and include equivalents, and may refer to average, median, representative, majority, etc. in some embodiments. Further, in this disclosure, the terms including, constituted by and having can refer independently to typically or broadly comprising, comprising, consisting essentially of, or consisting of in some embodiments. In accordance with aspects of the disclosure, any defined meanings of terms do not necessarily exclude ordinary and customary meanings of the terms.

Algae, a class of photosynthetic organisms, can be generally divided into microalgae and macroalgae. While macroalgae or “seaweeds” are multicellular plants that grow up to 60 meters in length, microalgae are photosynthetic unicellular microorganisms. Algal biomass is regarded as a sustainable feedstock due to its wide distribution, high environmental tolerance, rapid growth rate, and its high capacity for CO₂ fixation. Due to high nutrient uptake, algae usually dominate in high nutrient environments, at a growth rate that can double the algal biomass in periods as short as 3.5 hours. Microalgae can be cultivated in brackish water that is usually nonarable and thus does not compromise the cultivation of crops. Growth of algae could also take nutrients from organic effluent while simultaneously decontaminating it.

Algae, as high-efficient photosynthetic microorganisms, exhibit great environmental benefit by converting CO₂ together with sunlight and water into cells. For example, 1 gram of dry algal biomass was found to utilize 1.8 grams of CO₂.

Substantial ongoing research has been leading to the popularization of algae-based products that can be used in the pharmaceutical, cosmetic, food, agricultural and biofuel industries. Additionally, algae have also been adopted to decontaminate wastewater via a bio-adsorption process. Such adsorption capability is attributed to the presence of functional groups, including —COOH, —OH, —RCOO, —HPO₄²—, and —NH₂, from polysaccharides and lipids in the algae biomass.

The use of algae in cements has been limited. While one barrier could be the algae-induced biodeterioration on cements and geopolymers, the deterioration is mainly caused by the organism's physical activity (e.g., growth) and should be of no concern when their dead biomass is used. As an example application, the extract from marine brown algae acted as viscosity-enhancing admixture for cements via potentially forming a transient gel-like network of alginate chains and cement particles. Algae-derived biopolymers were used to mitigate shrinkage for cement pastes. Algae-dosed concrete samples also exhibited increased/comparable strength and enhanced durability in terms of chloride diffusion. Additionally, thermally-treated algae (or biochar) were shown to tailor physical properties, including strength and water absorption, and to promote carbonate formation under CO₂ curing and to enhance the sequestering of CO₂.

This disclosure relates to using algae as a hydration of hydraulic cement (or cement mixtures), such as portland cement. The algae can possess functional groups, such as —COOH and —OH, that exhibit potential for retarding the hydration. While some biopolymers (e.g., cactus mucilage) have exhibited retardation effects on cement hydration, the alginate-based biopolymer was found to accelerate the hydration of calcium alumina cements, because the —COOH groups absorb calcium ions and serve as nucleation sites for the formation of calcium aluminate hydrate phase. The presence of —COOH groups from the raw algae biomass can affect the hydration of hydraulic (e.g., portland) cements.

### SPECIFIC EXAMPLES

In the examples below; chlorella (one of the most studied microalgae) was studied to determine the algae's effect on the hydration of hydraulic (e.g., portland) cement and to understand the mechanisms associated with such effects: however, unless otherwise noted, the disclosure is not limited to such examples or algae. As set forth in more detail below, algae biomass was found to substantially retard the hydration of portland cement. To potentially promote the algae's application as a retarder, their effect on the microstructure and strength of the cement pastes were examined.

We have demonstrated for the first time that algae tailor the hydration kinetics of portland cements and elucidated the mechanisms. Specifically, the addition of chlorella (a widely cultivated type of algae) was found to substantially retard the cement hydration, as indicated by an 82.4% delay in the main peak of heat evolution measured by isothermal calorimetry. We further mechanistically elucidated that such retardation is caused by the —COOH and —OH functional groups, by having (1) confirmed their presence in the algae via FTIR, (2) demonstrated an enhanced retardation with increasing groups of —COOH and —OH, and (3) demonstrated an elimination of retardation by removing these groups in the algae through H₂O₂— and heat-treatment, respectively. Furthermore, the effects of algae on the morphology, crystal structures, and compressive strength of the cement pastes were found to be negligible, suggesting the algae's role as a potential retarder for cementitious materials.

Commercially available Type I/II portland cement (QuikreteR) that complies with ASTM C150 was used in this study. Chlorella pellets, from Earth Circle Organics (Las Vegas, NV), were ground with a mortar and pestle to pass through a sieve of a 125-μm opening, before adding into the cement pastes. Hydrogen peroxide (H₂O₂, 30%, Fisher Scientific, Waltham, MA) was also obtained and diluted for treating the chlorella algae before adding into the selected cement pastes.

In one treatment, the ground chlorella powders were heated using a Carbolite tube furnace under a 50 ml/min flow of N₂ gas. The temperature was increased from room temperature (around 20° C.) at 10° C./min to 300° C., a temperature that exhibited a maximum rate of thermal decomposition for a chlorella sample based on thermogravimetric analysis. Upon holding at 300° C. for 1 hour, the sample was then cooled down at 20° C./min to room temperature (around 20° C.).

In the other treatment, 10 grams of the ground chlorella powder were soaked in 200 ml of 10% H₂O₂ solution (which was diluted from a 30 wt % stock solution with de-ionized water) and kept stirring for 24 hours. The mixture was then centrifuged with a Thermo Scientific (Sorvall Legend X1R) at 5000 rpm for 30 minutes. Once the liquid was poured out, the solid residue was then mixed homogeneously with a total of 200 ml of de-ionized water (same amount as the initial 10 wt % H₂O₂ solution) and centrifuged for 30 minutes, a washing process that was repeated for a total of 3 times.

Each cement-paste sample, at a water to cement ratio of 0:4, was mixed with a Caframo Ultra Speed BDC6015 overhead stirrer at 140 rpm for 30 seconds and then at 285 rpm for 2.5 minutes, the same mixing protocol we adopted in an earlier study. In between the two-speeded mixing, materials on the edges of the mixing cup were scraped. In samples with addition of algae, either raw or H₂O₂/heat treated, the algae were intermixed with cement particles before further mixing with water. Immediately following mixing, the cement pastes were cured, at ambient conditions (approximately 30% humidity and 20° C. temperature) for 2 days and then in a sealed condition at ˜20° C. until further testing/processing. To stop the hydration for selected characterization tests, 1.0 gram of the paste samples, upon being ground to pass through a 125-μm sieve, was soaked in 50 ml of isopropanol for 15 mins.

Reaction kinetics of the cement pastes with and without addition of algae was monitored at 21° C. Each freshly mixed paste (˜14 g) was weighed in a glass ampoule and placed into a chamber of a Thermometric TAM Air 8-Channel Isothermal Conduction calorimeter. Siliceous sand (˜14 g) was used as the reference material. While the heat generated from the hydration was monitored, the heat evolution and total heat were normalized by weight of the cement paste.

The morphology of the algae particles was examined using a Hitachi SU3500 SEM instrument. The microscope was operated between 10 and 15 kV in secondary electron imaging mode. Prior to imaging, samples were coated with a gold film of ˜10 nm under a vacuum condition (<0.15 mb).

The nanostructures of the synthetic gels with and without sucrose were examined through an attenuated total reflectance (ATR) Fourier-transform infrared (FTIR) instrument (ThermoScientific Nicolet iS20 FTIR). Each spectrum was an average of 32 measurements scanned from 2000 to 600 cm⁻¹ at a resolution of 4 cm⁻¹.

After having understood the effects of algae on the hydration kinetics of cement pastes, their effects on the hardened properties, including the morphology, crystal structures and strength, were examined.

The fracture surfaces of the hardened cement pastes with and without addition of algae at 28-day curing were coated with gold film and examined under SEM, in the same condition for algae as described above (see above).

A Bruker D8 Advance XRD instrument was used to characterize the crystal structures of the cement pastes. Powders of each sample upon stopping reaction at 28-days curing were mixed with ethanol, and a thin layer of the paste was casted on a Si crystal zero-background plate. Each sample was scanned using Cu Ka X-ray radiation (wavelength 1.5406 Å) from 5 to 60° 20 with a step size of 0.02° and a dwell time of 2 seconds per step. Crystalline phases were identified using Bruker DIFFRAC.EVA software and the International Center for 20 Diffraction Data (ICDD) PDF-4 AXIOM 2019 database.

The compressive strength was measured for the cement pastes with and without algae at both 7 and 28 days of curing. Five cylindrical samples per test group were used in accordance with ASTM C39/C39M, a standard designed for concrete cylindrical samples. For our cement paste samples, we adopted smaller sized samples, specifically 12.5 mm in diameter and 25 mm in length. Samples were tested using an Instron Universal Testing Machine with 48.9 kN capacity at a loading rate of 0.25±0.05 MPa/s.

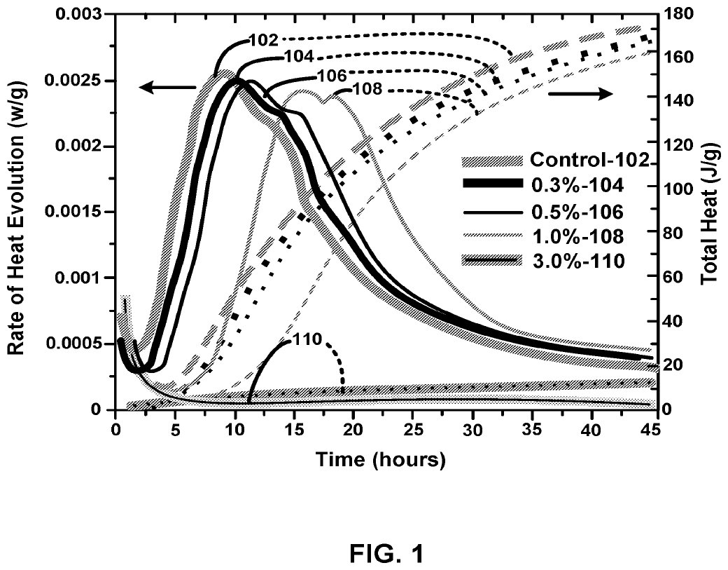

FIG. 1 shows the curves of heat evolution and total heat of the cement pastes with the raw ground chlorella powders, up to 3.0% by weight of cement. While the heat evolution for the 3.0% mixture remains low throughout the first 45 hours, the curves of all other mixtures exhibit a dormant period followed by a main reaction peak that is composed of acceleration and deceleration periods.

The right shift of the main reaction peak reveals a substantially-retarded hydration by the chlorella. Specifically, as summarized in Table 1, the peak time increases from 8.5 hours (control cement paste) to 11.0 hours (0.5% chlorella) and 15.5 hours (1.0% chlorella), respectively. A much further delay to 77.5 hours (not shown in FIG. 1) was observed for the 3.0%-chlorella dosed paste. Correspondingly, the total heat was much decreased, for example, from a 40-h heat of 163 J/g for the control paste to 1.7 J/g for the paste with addition of 3.0% chlorella.

TABLE 1
The peak time of the heat evolution and the total heat at 40 hours for
cement pastes with and without addition of algae.

| | | Peak time | | |
|---|---|---|---|---|
| | | | % | Heat at |
| | Chlorella | | compared | 40 hours |
| Cement pastes | wt % of cement | hours | to control | J/g |
| No additive | 0.0 (control) | 8.5 | NA | 163 |
| Raw algae | 0.3 | 9.9 | 16.5 | 162 |
| | 0.5 | 11.0 | 29.4 | 161 |
| | 1.0 | 15.5 | 82.4 | 155 |
| | 3.0 | 77.5 | 811.8 | 1.7 |
| Treated algae | 0.5 (H₂O₂ treated) | 12.8 | 50.6 | 162 |
| | 0.5 (heat treated) | 8.5 | 0 | 162 |

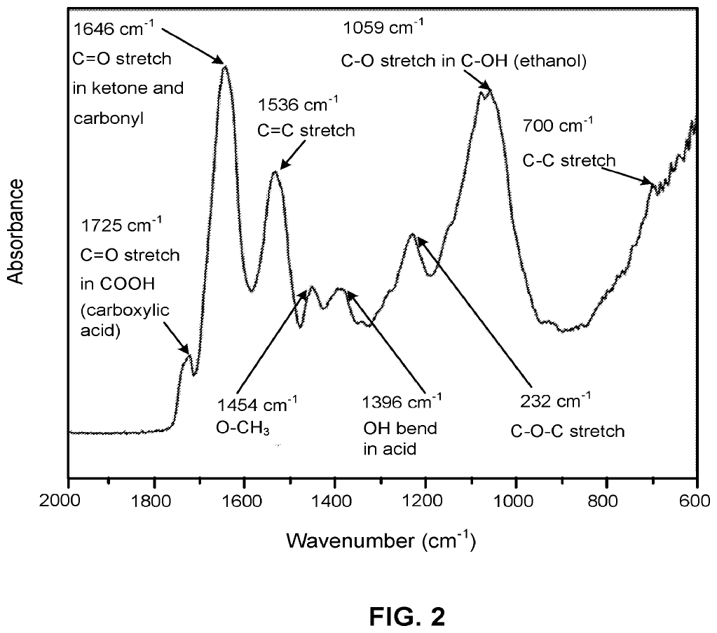

To understand the retardation mechanisms of the chlorella, its chemical structure was examined via FTIR. As labeled in FIG. 2, various functional groups were observed, including C═O in COOH (1725 cm⁻¹), C═O stretch in ketone and carbonyl acid (1646 cm⁻¹), O—CH₃ (1454 cm⁻¹), OH in acid (1396 cm⁻¹), C—OH (1059 cm⁻¹) and C—C(700 cm⁻¹), the assignments of which were based on an earlier study.

Among the above functional groups, the carboxyl (—COOH) and hydroxyl (—OH) groups have been found to retard the cement hydration. The addition of glycolic acid that possesses carboxyl and hydroxyl groups has shown to substantially retard the hydration of cement. For instance, addition of 0.2% glycolic acid extended the induction period from 1.5 to 8 hours for a cement paste (water/cement ratio of 0:35).

Mechanistically, the carboxyl and hydroxyl groups retard cement hydration via adsorption onto the cement phases, especially for hydroxylated C₃S. For instance, these functional groups from glycolic acid or calcium glycolate were hypothesized to interact with surrounding water molecules and form hydrogen bonds, which then form a stable hydrogen bond network covering the surfaces of the cement phase. Such hypothesis was supported by the experimental observation that calcium glycolate adsorbed on the calcium hydroxide surfaces. It was further supported by the simulation that showed the hydroxyl groups of calcium glycolate form a strong hydrogen bond with the calcium hydroxide and C₃S surfaces, a phenomenon that rejects other alternative mechanisms, such as that hydroxy carboxylic acids chelate calcium and adsorb on hydration products.

Such adsorption is confirmed by further nanostructural evidence. Based on a series of comprehensive 2D ¹³C-¹H and ²⁹Si-¹H NMR tests, the —COH and the CH₂OH functional groups from sucrose molecules were found to adsorb at silanol and silicate hydration products via hydrogen-bonding interactions. In another study by the same research team, carboxylic acids, as degradation products of glucose under alkaline solution, were found to non-selectively adsorb on hydrated silicates and aluminates (i.e., the hydration products of cement phases).

To further validate if the retardation effects of chorella demonstrated above are due to the presence of the —OH and —COOH functional groups, the chlorella was treated to potentially increase or reduce the amount of these groups, prior to mixing with the cement pastes.

One treatment was to heat the chlorella under N₂ gas, a common process for producing biochar. The other was to soak it in H₂O₂ solution. To examine any changes of the —OH and —COOH groups in the algae, we review the chemical (and physical) reactions that potentially occur during treatments and then present the experimental characterization of the associated structural changes.

Potential Chemical Reactions during Treatments

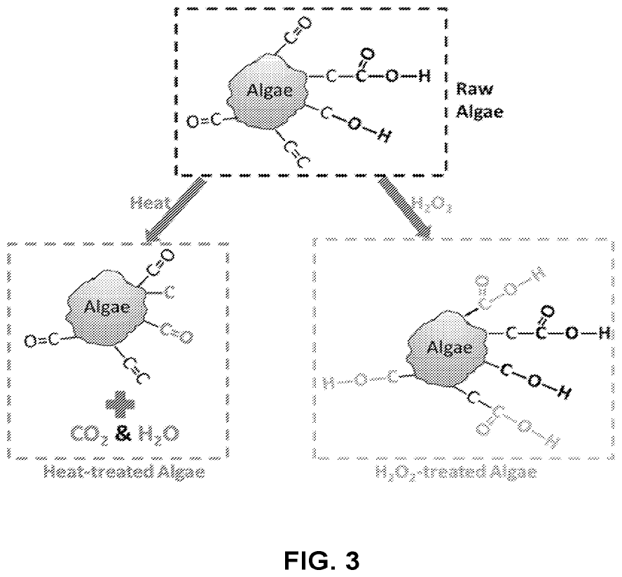

During heat treatment, algae go through a series of chemical (and physical) reactions. Under 150° C., the main change is the evaporation of free water. As temperature further increases, the proteins, lipids and carbohydrates from algae are decomposed. Taking lignocellulose and algae as an example, their pyrolysis between 300 and 400° C. generate CO₂, a reaction that has been attributed to the cracking and reforming of C═O and —COOH functional groups, as schematically depicted in FIG. 3. More specifically, for an algae sample, the CO₂ emission has been attributed to the decomposition of carbohydrates between 180° C. and 270° C. and protein from 320° C. to 450° C.

The H₂O₂ treatment, though only reported to oxidize the biochar samples so far, is hypothesized to also react with the raw algae biomass. In a biochar sample, H₂O₂ solutions (up to 30 wt %) increased the FTIR peak of —COOH (1700 cm⁻¹) but decreased that of C═C (1585 cm⁻¹), a change that occurs more substantially as H₂O₂ is more concentrated. This is consistent with an increase of —COOH groups in a peanut hull-based biochar upon H₂O₂ treatment. Additionally, such treatment increased the C—H peak (775 cm⁻¹), likely caused by the conversion of the C═C ring structure.

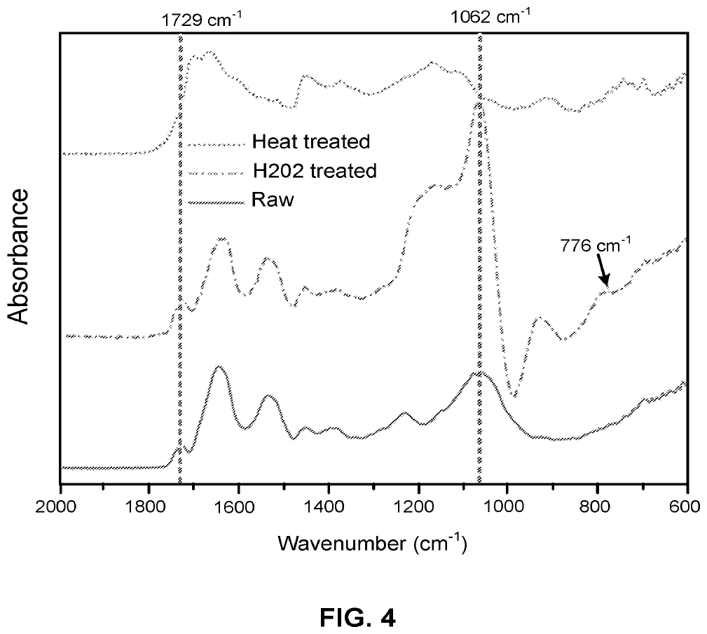

In FIG. 4, the FTIR spectra of both heat- and H₂O₂-treated chlorella, together with the raw chlorella, are presented. The two most substantial changes upon the treatments occur at peaks of 1729 cm⁻¹ and 1062 cm⁻¹, which are attributed to the —COOH and —OH groups, respectively. Specifically, while the H₂O₂ treatment enhanced both these peaks, the heat treatment decreased or even eliminated both of them. Such changes indicated that the —COOH and —OH groups were increased with the H₂O₂ treatment but substantially decreased with the heat treatment, an observation that aligns with the potential reactions discussed above.

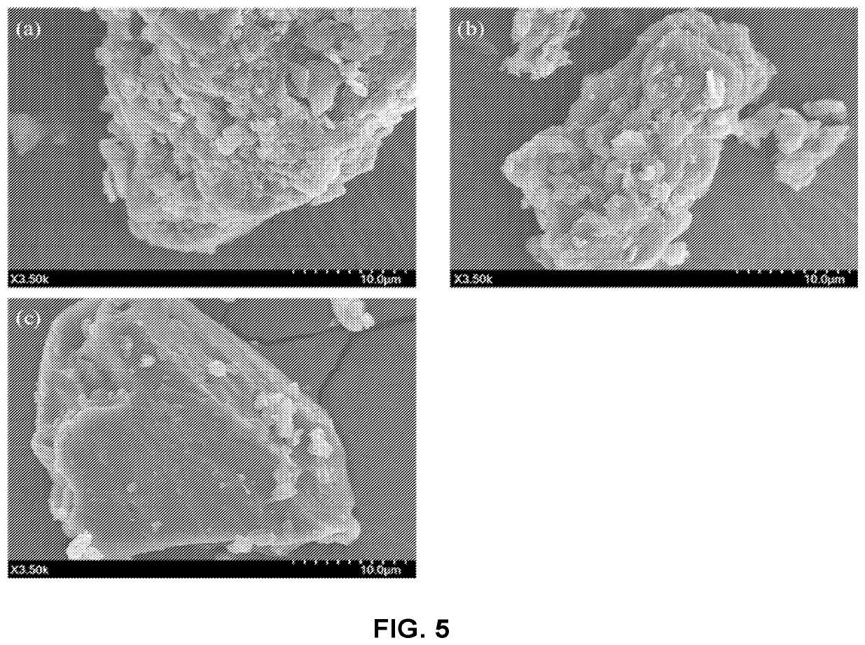

The morphological changes of the treated versus the raw algae were further examined under SEM. In FIGS. 5 (a, b), both the raw and H₂O₂-treated chlorella exhibited rugged surfaces that are composed of small-sized particles/plates (roughly under 5 μm in diameter). On the other hand, the surface becomes smooth upon the heat treatment, as shown in FIG. 5 (c). Such different morphology upon the heat treatment (i.e., lack of small-sized particles/plates) could relate to the disappearance of the —OH and —COOH functional groups as schematically and experimentally seen in FIG. 3 and FIG. 4. As an additional minor point, the clean and smooth morphology of the heat-treated sample suggests the treatment is gentle, consistent with an earlier examination that a 300° C. treatment did not cause porous and ruptured morphology as seen under higher temperatures.

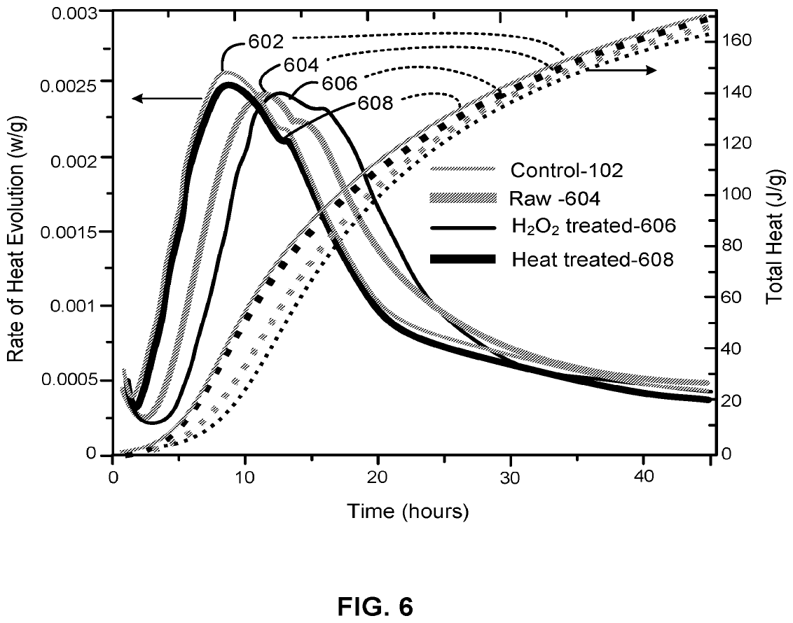

Calorimetry curves of cement pastes with and without the chlorella additives (raw, H₂O₂—, and heat-treated) are presented in FIG. 6. The “Control” and “Raw” curves in FIG. 6 are the same as curves of cement pastes with 0.0% (i.e., control 602) and 0.5% raw chlorella presented in FIG. 1. Compared to the sample with raw chlorella (604), the H₂O₂-treated chlorella (606) induced a further delay in the main reaction peak, specifically from 11.0 to 12.8 hours, as summarized in Table 1. To the contrary, the heat-treated chlorella (608) accelerated the peak position to 8.5 hours, which overlaps with the peak for the control paste (602). The 30) total heat for all these samples, however, remained approximately the same, for example, around 162 J/g at 40 hours (as summarized in Table 1). This same total heat at a relatively later age indicated that the algae-induced retardation occurs only temporally, a characteristic that is much preferred for retarders of cementitious materials.

The discrepancy in such retardation versus acceleration is likely caused by the different structural changes induced by these treatments. The H₂O₂ treatment increased the —COOH and —OH functional groups, while the heat treatment has removed these two functional groups. Considering the capability of these groups to substantially retard the cement hydration as mechanistically discussed above, the further retardation with H₂O₂ treatment but acceleration with heat treatment provided further direct evidence that —COOH and —OH groups are the origin of the algae's retardation.

We have validated the strong retardation effects of algae (i.e., chlorella as a typical type) and found out the retardation was due to the presence of the —COOH and —OH functional groups. Considering that algae are widely and cheaply available, their strong retardation effects could potentially be exploited in engineering practice. Here we show the structures and mechanical strength of the algae-dosed cement pastes. Since the heat-treated algae exhibited no retardation (FIG. 6), here we only focus on raw and oxidized (H₂O₂-treated) algae.

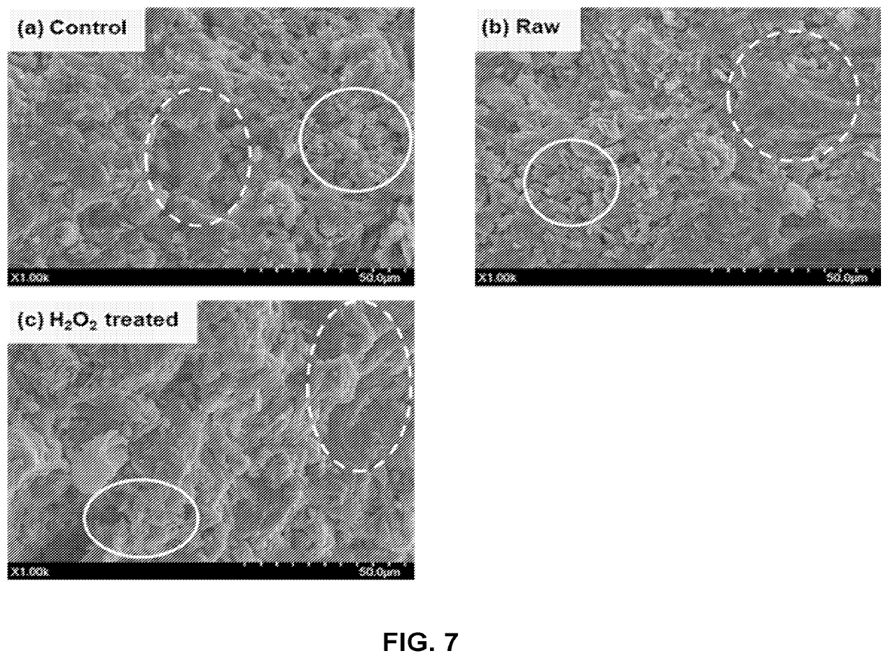

FIG. 7 shows the morphology of cement pastes with and without additive of algae. The control paste (“control”) and those with raw and H₂O₂-treated algae all exhibit a pretty dense microstructure. Upon a closer look, all these pastes exhibit both relatively-smooth (dashed oval) and rough (solid oval) fracture surfaces. While the rough-surface region is composed of small particles that could be calcium silicate hydrate particles, the smooth surface is likely the particles that have evolved into a bulk structure. We could not clearly identify the presence of any algae, likely due to the low dosage (0.5 wt %). Overall, the addition of the raw- and H₂O₂-treated chlorella does not appear to alter the microstructure of the cement pastes.

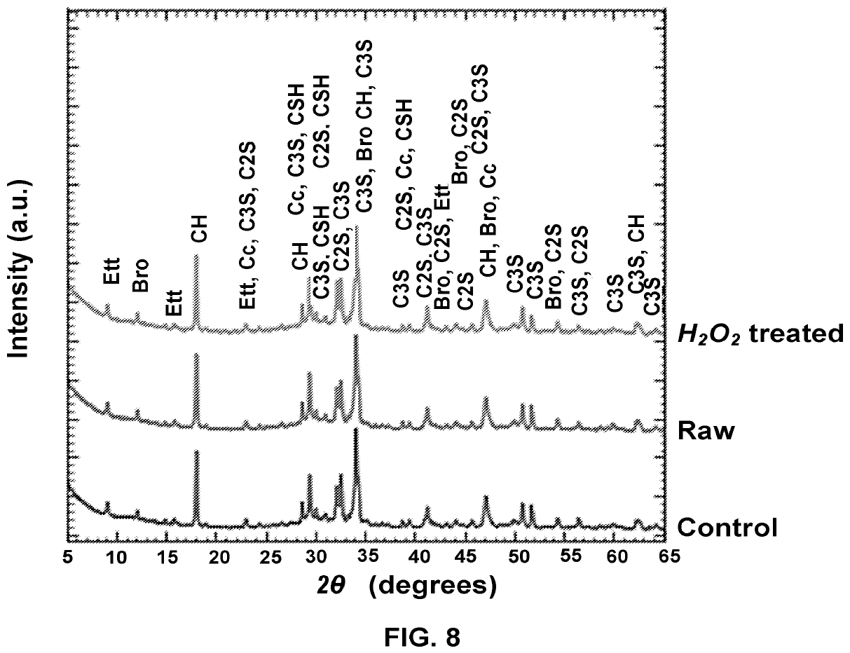

FIG. 8 shows XRD patterns for control, raw; and H₂O₂ treated cement pastes after 28 days of curing. Diffraction peaks occur at the same angles and with the same intensities for all three cement pastes. Search and match results also indicate the formation of the same hydrated cement phases for the control, raw, and H₂O₂ treated pastes. The presence of similar hydrated phases between pastes is consistent with SEM results which show no significant change in morphology with the addition of raw or treated chlorella. While addition of algae delays hydration kinetics, it does not appear to alter the crystal structures of the hydration products.

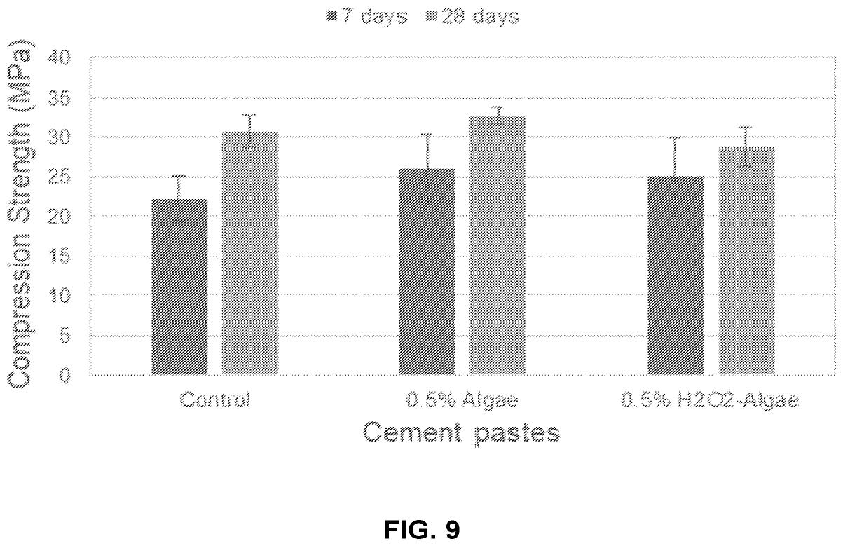

The compressive strength of the control cement paste and those with addition of raw—and H₂O₂-treated chlorella is shown in FIG. 9. All the pastes exhibited an increase of strength from 7 to 28 days. Compared to the control paste, the addition of algae exhibited a comparable, or even higher, strength at both 7 and 28 days, for example, from 22 MPa for control paste to 26 MPa for raw chlorella dosed paste at 7 days. The comparable or even slightly increased strength is consistent with the calorimetry and SEM results. Despite a delay of reaction at the early age, the addition of the algae exhibited similar accumulated heat at around 40 hours and later (see FIG. 6). The addition of algae does not induce any morphological changes in the cement pastes from the SEM examination (see FIG. 7). Such minimal effects on strength and microstructures indicate a great potential of chlorella, as a typical type of algae, to be promoted as a sustainable bio-based retarder for cementitious materials.

We have demonstrated and understood the retardation effects of chlorella (a typical algae) on cement hydration. A high retardation efficiency has been observed, given that 1 wt % of algae delayed the main peak of the heat evolution by 82.4%, a degree of retardation slightly higher than that seen with 0.15 wt % of sucrose (a well-known strong retarder for cements). Considering algae's wide availability and sustainability as reviewed in the introduction, they could be regarded as a sucrose's competitor for retarders. Furthermore, the addition of algae was found to not affect the microstructures and compressive strength of the cement pastes, further suggesting the potential of algae to be used as a retarder in engineering practice.

Besides serving as a retarder and other similar applications (e.g., viscosity-modifying agent), algae exhibit great potential for developing functional cementitious materials. The introduction of algae, among other microorganisms, potentially equips cementitious materials with functionality of removing heavy metal in waste water and cleaning pollutants from the air. Additionally, the algae's functional groups (e.g., —COOH, —OH, —RCOO⁻, —HPO₄²—, —NH₂) exhibit great potential to be functionalized with other organic/inorganic or metallic materials and functional components, as seen in fields of cementitious materials materials/biotechnologies, implicating a promising area of algae-based functional cementitious materials (including geopolymers).

In terms of potential large-scale applications, the advantage of algae-based admixtures lies in their cost effectiveness on top of the other benefits (as detailed in the introduction). Considering that algae cost between $472-$1137 per ton and 1 m³ of concrete normally consumes ˜450 kg cements, an addition of 0.5 wt % algae (i.e., 2.25 kg) would cost around $1.6-$2.6, a rate that lies at the lower end for typical chemical admixtures of cementitious materials. This could be even more promising as significant (more than 50%) cost reductions of the algal production can be achieved when using lower cost CO₂, nutrients and water, a condition that is likely suitable for the growth of algae due to their high environmental tolerance.

We have for the first time substantiated that algae (e.g., chlorella) retards the hydration of hydraulic (e.g., portland) cements and elucidated the mechanisms involved with this retardation. Moreover, the addition of algae was found not to affect the microstructures and strength of the cement pastes, suggesting the potential role of algae to serve as a retarder for cementitious materials.

The retardation effects of algae were confirmed via calorimetry. The heat-evolution peak for the cement hydration was substantially delayed, specifically by 29.4%, 82.4% and 811.8% with addition of 0.5%, 1.0% and 3.0% of algae, respectively.

Such retardation is caused by the —COOH and —OH functional groups of the algae. While —COOH and —OH are retarding functional groups for cementitious materials, their presence in the algae was confirmed via our FTIR tests. Furthermore, we have demonstrated an enhanced retardation by algae with enhanced —COOH and —OH groups but an elimination of retardation by reducing these groups in the algae, through H₂O₂ and heat treatment, respectively.

To ultimately promote algae as a retarder for cements in engineering practice, we have further demonstrated that the addition of algae exhibited negligible effects on the morphology, crystal structure, and mechanical strength of the cement pastes. Considering the high retarding efficiency and negligible effects on structures and strength, the low economical cost on top of high environmental benefits promises a large-scale application of algae in cementitious materials.

1. A cement mixture comprising:
about 0.01 wt % to about 10.0 wt % hydration retarder by weight of the cement, the hydration retarder comprising algae.

2. The cement mixture of claim 1, comprising about 0.3 wt % to about 3.0 wt % of algae by weight of the cement.

3. The cement mixture of claim 1, wherein the algae comprise one or more of chlorella, spirulina, and chlorophyta.

4. The cement mixture of claim 1, wherein the algae are not living.

5. The cement mixture of claim 1, wherein the algae are living.

6. The cement mixture of claim 1, wherein the algae comprise microalgae.

7. The cement mixture of claim 1, wherein the cement comprises hydraulic cement.

8. The cement mixture of claim 1, wherein the cement comprises portland cement.

9. The cement mixture of claim 1, wherein the cement comprises one or more of basic oxygen furnace (BOF) or ground granulated blast furnace slag cement, alkali-activated cement, sulfoaluminate cement, magnesium phosphate cement, carbonated cement, calcium aluminate cements

10. The cement mixture of claim 1, wherein the algae comprise one or more of a carboxylic acid functional group and a hydroxyl functional group.

11. The cement mixture of claim 1, wherein the algae comprise the carboxylic acid and the hydroxyl functional group.

12. The cement mixture of claim 10, wherein the algae comprise algae treated with an oxidant to increase a number of one or more of the carboxylic acid functional groups and hydroxyl functional groups.

13. A cement additive for retardation of cement hydration, the cement additive comprising:
algae.

14. The cement additive of claim 13, wherein the algae have been ground to an average size between about 0.1 μm and about 1 mm or between about 100 μm and about 250 μm.

15. The cement additive of claim 13, wherein the algae has passed through a sieve having a size of about 125 μm or less.

16. The cement additive of claim 13, wherein the algae has been modified to add one or more functional groups selected from the group consisting of a carboxylic acid group and a hydroxyl functional group.

17. A method of forming a hydration retarder for cement, the method comprising the steps of:
providing algae, and
optionally exposing the algae to an oxidant to increase an amount of one or more of a carboxyl group and a hydroxyl group on a surface of the algae.

18. The method of claim 17, comprising the step of exposing the algae to the oxidant.

19. (canceled)

20. (canceled)

21. The method of claim 17, further comprising a step of grinding the algae to form ground algae.

22. The method of claim 21, further comprising a step of passing the ground algae through a sieve.

23. (canceled)

24. (canceled)

25. (canceled)

26. (canceled)

27. (canceled)

28. (canceled)
